(19) United States
(12) Patent Application Publication
(10) Pub. No.: US 2023/0016726 A1
(43) Pub. Date: Jan. 19, 2023

(54) BIDIRECTIONAL ELECTRICAL SYSTEMS WITH HIGH-VOLTAGE VERSATILE BATTERY PACKS

(71) Applicant: EnerSys Delaware Inc., Reading, PA (US)

(72) Inventors: Rui Zhou, Niskayuna, NY (US); Mohammed Kechmir, Wyomissing, PA (US); Rhodri Evans, Newport (GB); Joern Tinnemeyer, Reading, PA (US)

(21) Appl. No.: 17/858,359

(22) Filed: Jul. 6, 2022

Related U.S. Application Data
(60) Provisional application No. 63/219,098, filed on Jul. 7, 2021.

(51) Int. Cl. H02J 7/00; H02J 3/32; H02J 7/34

(52) U.S. Cl. CPC H02J 7/0024; H02J 3/32; H02J 7/342

(57) ABSTRACT

Bidirectional electrical power systems are provided that include versatile battery packs. For example, a battery pack is introduced which may have both a first interface or port for high voltage fast charging and discharging, and a second interface or port for low voltage supply of power to present equipment without requiring modification or retrofitting. The battery pack may include, for example, a first battery module within the battery pack; a second battery module within the battery pack; and a switching matrix within the battery pack and configured to connect the first and second battery modules in series or in parallel.

### CROSS-REFERENCE TO RELATED APPLICATION

The present application claims the benefit of priority to U.S. Provisional Application No. 63/219,098, filed on Jul. 7, 2021, and the entire contents of the above-identified application are incorporated by reference as if set forth herein.

### TECHNICAL FIELD

The present disclosure relates to electrical systems, and in particular relates to bidirectional electrical systems with high-voltage versatile battery packs.

### BACKGROUND

Electrical power systems are used to supply electrical power and are used in a variety of applications. Some electrical power systems of increasing interest are those that use stores of electrical energy to provide electrical power. Although electrical energy can be converted and stored in a variety of devices (e.g., potential energy storage devices, thermal energy storage devices), a common energy storage device is a battery device comprising one or more batteries and/or battery cells. This energy storage can be provided either as a supplement to main power or grid power, or as a partial or even total replacement of grid power.

Some electrical power storage systems supply power to residential, commercial and industrial buildings and electrical equipment therein. Some electrical power systems provide stored electrical energy to electric vehicles (including electric cars and other vehicles, such as forklifts, trucks, and so on). Some electrical power storage systems are used to supply backup power in telecommunication systems or in industrial un-interruptive power systems. Other applications exist as well.

Some specific systems of interest include energy storage systems (ESS) in which electrical energy is obtained and stored from a main grid for local use (e.g., for a single building or campus) during periods when the electrical energy is available at lower prices and/or when an increased amount of electrical energy can be more easily produced (e.g., when favorable environmental conditions are present). In periods of increased demand, decreased supply, and/or increased prices, energy stored in the ESS may be used by the building or campus to supplement or replace the electrical energy used from the grid.

Interest and research in batteries has resulted in a variety of battery chemistries, with differing benefits and drawbacks. For example, “flooded” lead-acid batteries tend to be more economical, but may require periodic maintenance such as replenishment of an electrolyte, which can spill. “Sealed” lead-acid batteries may require periodic maintenance via charging or “overcharging” of the battery to prevent stratification. or such batteries may also have reduced capacity over time resulting from liberation of acid during charging. Alternative lead-acid batteries may use a gelled electrolyte, which cannot spill and avoid the acid liberation problem, but have their own drawbacks in that the internal resistance may be higher, limiting the ability of such batteries to deliver high currents. Of particular interest are lithium-ion batteries, which may offer low maintenance characteristics and high energy densities with manageable drawbacks, such as limitations on voltage levels during charge and discharge. Also of interest are thin plate pure lead (TPPL) batteries, which are an advanced form of lead acid batteries that offer faster charging and claim to be “maintenance free.”

### SUMMARY

Some aspects of the present disclosure provide bidirectional electrical systems with high-voltage versatile battery packs. According to some aspects of the present disclosure, a battery pack may include a first battery module within the battery pack. The pack may include a second battery module within the battery pack. The battery pack may include a switching matrix that is configured to connect the first and second battery modules in series or in parallel.

According to some aspects of the present disclosure, a battery pack may include a first battery module within the battery pack. The battery pack may include a second battery module within the battery pack. The pack may include a third battery module within the battery pack. The battery pack may include a first switching matrix within the battery pack and configured to connect the first and second battery modules in series or in parallel. The battery pack may include a second switching matrix within the battery pack and configured to connect the second and third battery modules in series or in parallel.

According to some aspects of the present disclosure, a battery pack may include at least two battery modules within the battery pack. The battery pack may include a switching network within the battery pack and configured to connect the at least two battery modules in series, in parallel, or in a combination of series and parallel. The battery pack may include first and second alternating current/direct current (ac/dc) converters, each coupled to a respective port of the battery pack.

In some aspects or embodiments of the present disclosure, one or more of the following features may be included. The switching matrix may include first and second solid state switches configured to operate together as a bidirectional switch. The switching matrix may include a high voltage port and a low voltage port. The switching matrix may include third and fourth solid state switches each configured to operate as a unidirectional switch. The first and second battery modules each may include first and second nodes, and the first and second solid state switches may be on an electrical path between the second node of the first battery module and the first node of the second battery module. The third solid state switch may be on an electrical path between the first node of the first battery module and the first node of the second battery module, and the fourth solid state switch may be on an electrical path between the second node of the first battery module and the second node of the second battery module. The battery pack may include a controller configured to control the switching matrix to connect the first and second battery modules in series by turning on the first and second solid state switches configured to operate together as the bidirectional switch. The battery pack may include a controller configured to control the switching matrix to connect the first and second battery modules in parallel by turning on the third and fourth solid state switches. The battery pack may include first and second ports.

The present disclosure is not limited to the aspects or embodiments discussed in this summary section, and other aspects and/or embodiments are disclosed herein.

### BRIEF DESCRIPTION OF THE FIGURES

FIG. 1 is a diagram illustrating aspects of a bidirectional electrical power system according to some embodiments.

FIG. 2 is a diagram illustrating aspects of a battery module used within the bidirectional electrical power system of FIG. 1.

FIG. 3A is a diagram illustrating how multiple battery modules may be configured in series to provide a higher voltage operation, and FIG. 3B is a diagram illustrating how multiple battery modules may be configured in parallel to provide a lower voltage operation.

FIG. 4 is a diagram illustrating aspects of a switching network that enables selective configuration of the bidirectional electrical power system having two battery modules for either a higher voltage operation or a lower voltage operation.

FIG. 5A is a diagram illustrating how the switching network of FIG. 4 can be configured to couple two battery modules to provide a higher voltage operation, and FIG. 5B is a diagram illustrating how the switching network of FIG. 4 can be configured to couple two battery modules to provide a lower voltage operation.

FIG. 6 is a diagram illustrating aspects of a switching network that enables selective configuration of the bidirectional electrical power system having N battery modules for a higher voltage operation, a lower voltage operation, or an intermediate voltage operation, where N is a natural number greater than or equal to three.

FIG. 7A is a diagram illustrating how the switching network of FIG. 6 can be configured to couple the N battery modules to provide a higher voltage operation, FIG. 7B is a diagram illustrating how the switching network of FIG. 6 can be configured to couple the N battery modules to provide a lower voltage operation, and FIG. 7C is a diagram illustrating how the switching network of FIG. 6 can be configured to couple the N battery modules to provide an intermediate voltage operation.

FIG. 8 is a diagram illustrating aspects of a bidirectional electrical power system according to some embodiments.

### DETAILED DESCRIPTION

The present disclosure is based on the recognition that the adoption of new storage systems of electrical energy by customers in various applications may in some cases be slowed or halted by marketplace and design considerations constraints. Selection of new battery chemistries and/or new battery voltages may necessitate concurrent adoption of new charging systems and in some instances even new operating equipment (such as a new fleet of forklift trucks or electric vehicles), requiring large capital expenditures. For example, some forklift trucks or electric vehicles may be manufactured according to one battery specification, and adopting a new battery specification may require either significant retrofitting of the forklift trucks or electric vehicles and/or require the new battery specification to maintain backwards compatibility with the original specification. Some organizations and individuals may be unwilling to overhaul their operations partially or totally, even for increased energy efficiency.

The present disclosure is also based on the recognition that at present batteries that are part of energy storage systems (ESS) are deployed as separate entities from batteries provide power for other applications. This is in part because of different technical requirements for different use cases, even while some battery chemistries may support multiple use cases. For example, a battery (such as a lithium-ion battery) used in grid support functions such as peak shaving, time of use, and frequency and voltage support (e.g., a battery used in an ESS) may need to operate at a high voltage. On the other hand, a battery (such as a lithium-ion battery) used to power an electric vehicle or forklift may operate at a lower voltage. This has resulted in reduced adoption for both the batteries used for ESS and the batteries used for the other applications, because of the increased costs of maintaining separate battery systems.

The present disclosure is also based on the recognition that safety and user experience factors may be contributing to lower adoption rates of electric vehicles and electric storage systems. Downtime is a significant concern to many individuals or organizations. Many customers may be unwilling to wait longer for a battery charge than it would take to fill up a gas tank for an internal combustion engine. Many businesses are unwilling or unable to accept forklift downtime, and either continue to use gas-powered engines (which can be rapidly refilled) or purchase systems with swappable batteries. Fast charging of large capacity batteries may require large amounts of current supplied through charging cables when the battery voltage is low. This may result in unacceptably large cables and/or delivery of unsafe amounts of current. Alternatively, although high voltage batteries would reduce the charging cable size and weight and enable lower current, such high voltage batteries would be unable to interface with present equipment, resulting in again some of the recognized issues discussed above.

To address the above technical problems, as well as other technical problems, the present disclosure provides bidirectional electrical power systems that include versatile battery packs. For example, the inventive concepts of the present disclosure introduce a battery pack which has both a first interface or port for high voltage fast charging and discharging, and a second interface or port for low voltage supply of power to present equipment without requiring modification or retrofitting. The inventive concepts of the present disclosure also provide for applications and usages of the bidirectional electrical power systems and/or versatile battery packs.

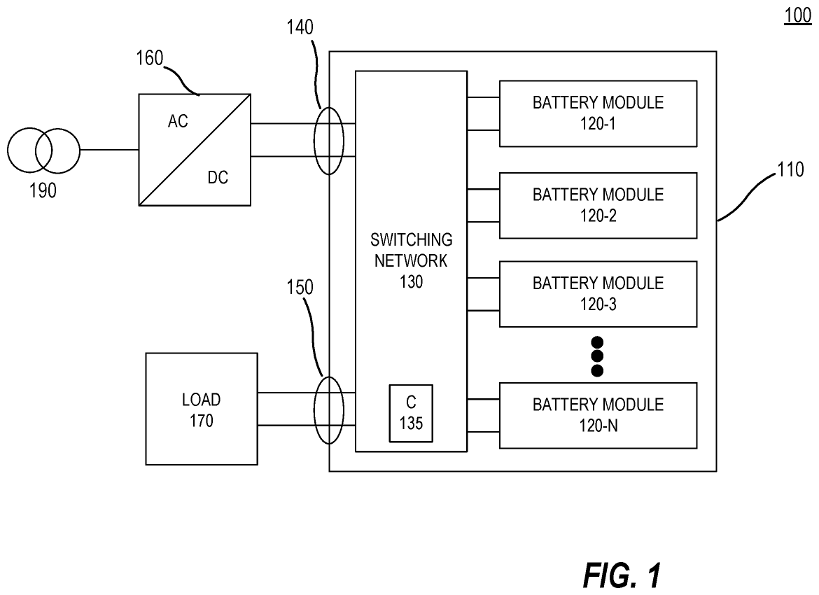

An example embodiment of a bidirectional electrical power system 100 is provided in FIG. 1. The bidirectional electrical power system 100 may include a battery pack 110 that includes one or more (and preferably, two or more) battery modules 120, a switching network 130, a first port 140, and a second port 150, and an AC/DC converter (or rectifier) 160. A load 170 and a grid or main power source 190 are also shown, but may not be part of the bidirectional electrical power system 100. In some embodiments, the AC/DC converter 160, which is shown separately from the battery pack 110 in FIG. 1, may be integrated with the battery pack 110.

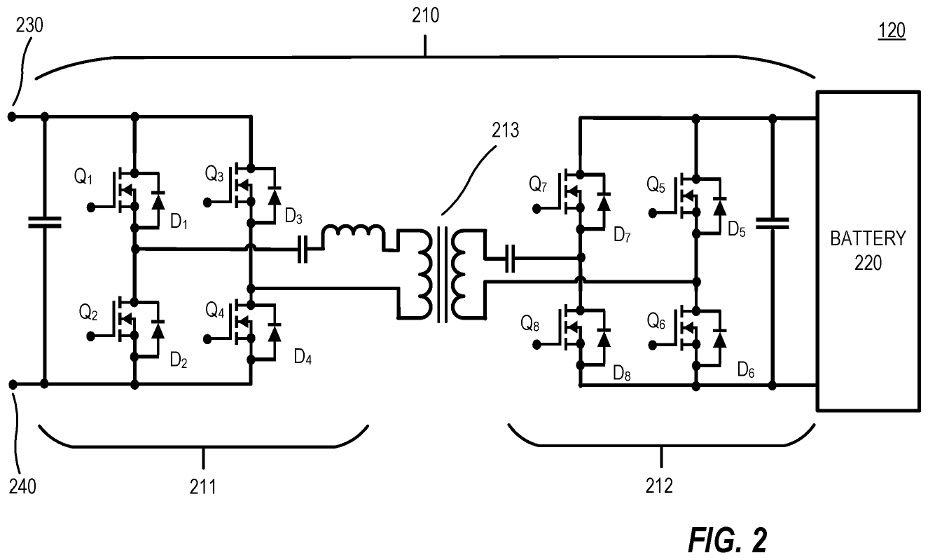

An example of one of the one or more battery modules 120 is shown in FIG. 2. The battery module 120 may include a battery 220 of any chemistry, which may be in some embodiments a lithium-ion battery chemistry or a TPPL battery. The battery module 120 may also include a first node 230 and a second node 240, which are connectable to the switching network 130 of FIG. 1. A bidirectional direct current/direct current (DC/DC) converter 210 may be between the first and second nodes 230 and 240 and the battery 220.

The bidirectional DC/DC converter 210 may include a first stage 211, a second stage 212, and a transformer 213. Each of the first and second stages 211 and 212 may be or may include a full bridge inverter/rectifier that each includes, for example, four solid state switching devices Q₁-Q₄ or Q₅-Q₈, which may be implemented as transistors (e.g., metal-oxide-semiconductor FETs (MOSFETs), and corresponding diodes D₁-D₄ or D₅-D₈. Although the diodes D₁-D₈ are shown in the illustrations and discussed separately, it may be understood that these diodes may be body diodes present in the semiconductor solid state switching devices Q₁-Q₈, and the diodes D₁-D₈ may not be separately implemented components. Additionally, although the transistors are shown as n-type MOSFETs (NMOS) it may be understood that other types of MOSFETs and/or other types of transistors (e.g., Junction FETs (JFETs) or BJTs) may be used.

Switches Q₁-Q₄ of the first stage 211 and switches Q₅-Q₈ of the second stage 212 may be controlled by one or more controllers (not shown in FIG. 2) to facilitate the transfer of power between the nodes 230 and 240 and the battery 220. T

The switches Q₁-Q₄ of the first stage 211 may be divided into two pairs, a first pair (Q₁ and Q₄) and a second pair (Q₂ and Q₃) and the switches of each pair may be driven simultaneously (e.g., switches Q₁ and Q₄ are turned on in unison). The switches may be controlled according to a switching frequency. In some embodiments, the switching frequency may be a variable switching frequency. The switches Q₁-Q₄ and the four diodes D₁-D₄ of the first stage 211 operate in concert to convert a DC power signal on the nodes 230 and 240 into an alternating current (AC) power signal supplied to the transformer 213, or in the opposite direction, convert an AC power signal supplied from the transformer 213 to the nodes 230 and 240 as a DC power signal.

The switches Q₅-Q₈ of the second stage 212 may be divided into two pairs, a first pair (Q₅ and Q₈) and a second pair (Q₆ and Q₇) that are driven in a similar manner as the switches of the first stage 211. The switching devices Q₅-Q₈ and the four diodes D₅-D₈ of the second stage 212 operate in concert to convert an AC power signal supplied from the transformer 213 to the battery 220 as a DC power signal, or in the opposite direction convert a DC power signal from the battery 220 into an AC power signal supplied to the transformer 213.

In some embodiments, the first stage 211 and/or the second stage 212 includes a resonant tank arranged between the switches thereof and the transformer 213. The AC output of the first stage 211 and/or the second stage 212 may power the resonant tank and cause power to be transmitted. In some embodiments, the resonant tank comprises at least one capacitor arranged in series with the transformer 213. In alternative embodiments, the first stage 211 and/or second stage 212 powers the transformer 213 directly and without a resonant tank.

The bidirectional DC/DC converter 210 may be configured to generate a DC output. In some embodiments, the bidirectional DC/DC converter 210 comprises a buck converter, but other types of DC/DC converter may be used in other embodiments.

In some embodiments, the bidirectional DC/DC converter 210, and the transformer 213 thereof, may be implemented with one of a number of different turn ratios.

In some embodiments, the controller of the bidirectional DC/DC converter 210 may disable the bidirectional DC/DC converter 210 when a fault in battery 220 is detected.

In some embodiments, the switching devices Q₁-Q₈ may be wide band-gap semiconductor devices, such as gallium nitride (GaN) or silicon carbide (SiC) devices, although the present disclosure is not limited thereto. In some embodiments, the bidirectional DC/DC converter 210 may have a power density exceeding 60-100 W/in³. In some embodiments, the efficiency of the bidirectional DC/DC converter 210 may reach 99%. A high power density and/or high efficiency of the bidirectional DC/DC converter 210 may make it suitable to be integrated within the battery module 120.

Returning to FIG. 1, the battery modules 120 may be connected to a switching network 130 within the battery pack 110. The switching network 130 may be configured to connect the battery modules 120 in various configurations, resulting in different voltages across the battery modules 120. The switching network 130 may also be configured to connect the battery modules 120 with either the first port 140 or the second port 150 and bidirectionally communicate power between the battery modules 120 with either the first port 140 or the second port 150.

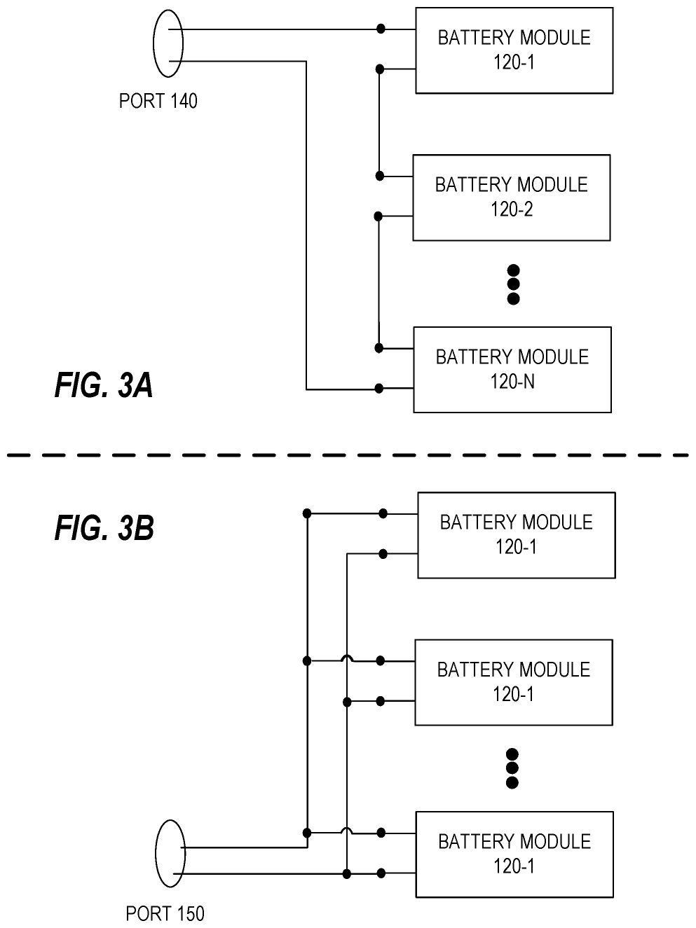

The switching network 130 enables the battery pack 120 to be reconfigurable selectively and thereby support different modes of operation or different use cases. For example, FIG. 3A is a diagram illustrating how multiple battery modules 120-1 . . . 120-N may be configured in series to provide a higher voltage operation, and connected to first port 140. This configuration may provide a high voltage interface with a bidirectional AC/DC converter 160. Configuration of the battery modules 120-1 . . . 120-N in series may enable a faster charging of the batteries 220 of the battery pack 110 from the grid 190, and in addition permit the usage of a DC bus bar or DC cable between the AC/DC converter 160 and the first port 140 of the battery pack 110. In this configuration, the battery pack 110 may be able to provide grid support to the grid 190 with high power output, and may be able to facilitate functions such as peak shaving, time of use, volt/VAR support, and frequency regulation.

As another example, FIG. 3B is a diagram illustrating how multiple battery modules 120-1 . . . 120-N may be configured in parallel to provide a lower voltage operation and connected to second port 150. This lower voltage may be used in applications, such as where the load 170 typically has lower power rating and/or it is desired that the load 170 is powered by the battery pack 110 for a relatively long duration of time. For example, it may be desirable for an electric vehicle or forklift to operate on a single charge for an entire work shift, e.g., 6-8 hours.

The ability to reconfigure selectively the connections of the battery modules 120 of the battery pack 110 enables a single battery pack 110 to support both higher voltage and lower voltage applications, and facilitate intersectional applications therebetween. For example, the battery pack 110 may be used in a forklift application for a long period of time, such as several hours, using the parallel connections of FIG. 3B. Then, the battery pack 110 may be connected to a charger and the switching network 130 may be controlled to configure the connections between the battery modules 120 from parallel connections with the second port 150 to a series connection with the first port 140, and subsequently the battery pack 110 (and the batteries 220 thereof) may be fast charged. This may significantly reduce a time needed to charge the battery, reducing down time. For example, this may enable fast charging times of as low as 5-15 minutes for forklift applications, and 5-10 minutes fast charging for electric vehicle applications, potentially enabling competitiveness of electric engines with conventional internal combustion engines.

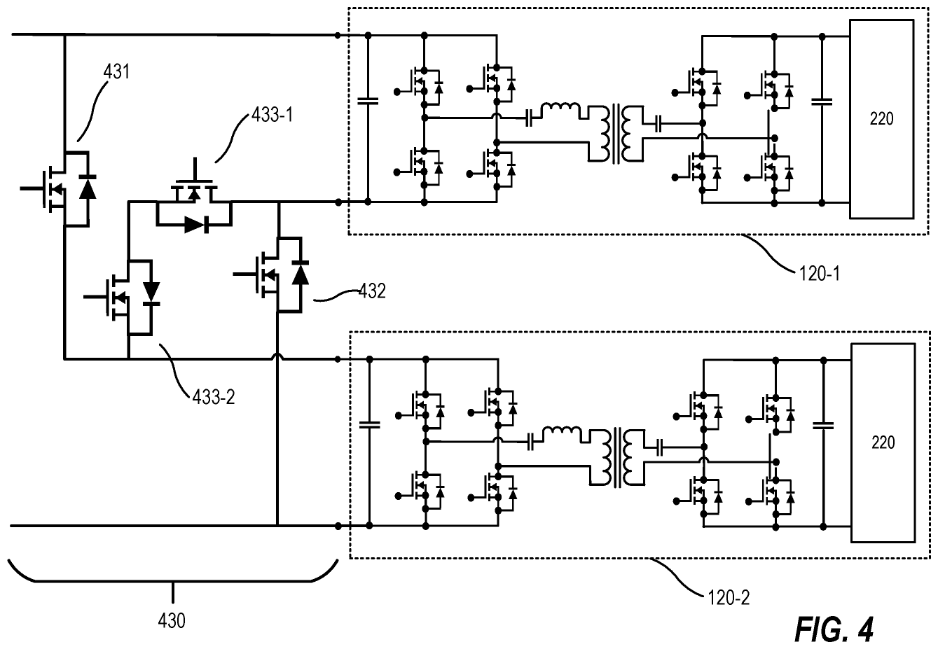

FIG. 4 illustrates an example switching network 130 for an implementation of a battery pack 110 that includes first and second battery modules 120-1 and 120-2. The switching network 130 may include a switching matrix 430 that includes two unidirectional switches 431 and 432 and a bidirectional switch 433 that includes two switches 433-1 and 433-2. The unidirectional switches 431, 432, and the switches 433-1, and 433-2 of the bidirectional switch may include a switching device (which may be a transistor, such as a MOSFET). As with the diodes of FIG. 2, diodes are shown in FIG. 4 and discussed separately, but it may be understood that these diodes may be body diodes present in the semiconductor solid state switching devices 431 432, 433-1, and 433-2 rather than separate discrete components.

The two switches 433-1 and 433-2 forming the bidirectional switch 433 may be arranged such that the bidirectional switch 433 is be blocking in both directions. As a result, no current will flow between the switching devices 433-1 and 433-2 of the bidirectional switch 433 unless both switching devices 433-1 and 433-2 are turned on. The switches 433-1 and 433-2 may each be implemented as a unidirectional switch. Conversely, the two unidirectional switches 421 and 422 may be configured to block the flow of current in only one direction.

A first of the unidirectional switches 431 is along an electrical path between the first nodes 230 of each of the battery modules 120-1 and 120-2, and a second of the unidirectional switches 432 is on an electrical path between the second nodes 240 of each of the battery modules 120-1 and 120-2. The two switches 433-1 and 433-2 of the bidirectional switch 433 are both along an electrical path between the second node 240 of the first battery module 120-1 and the first node 230 of the second battery module 120-2.

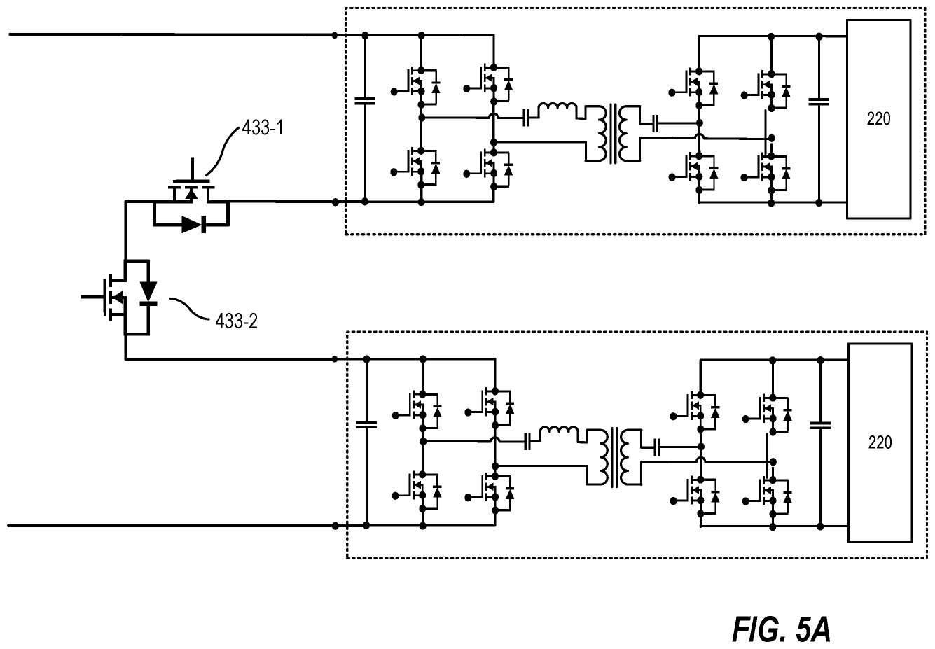

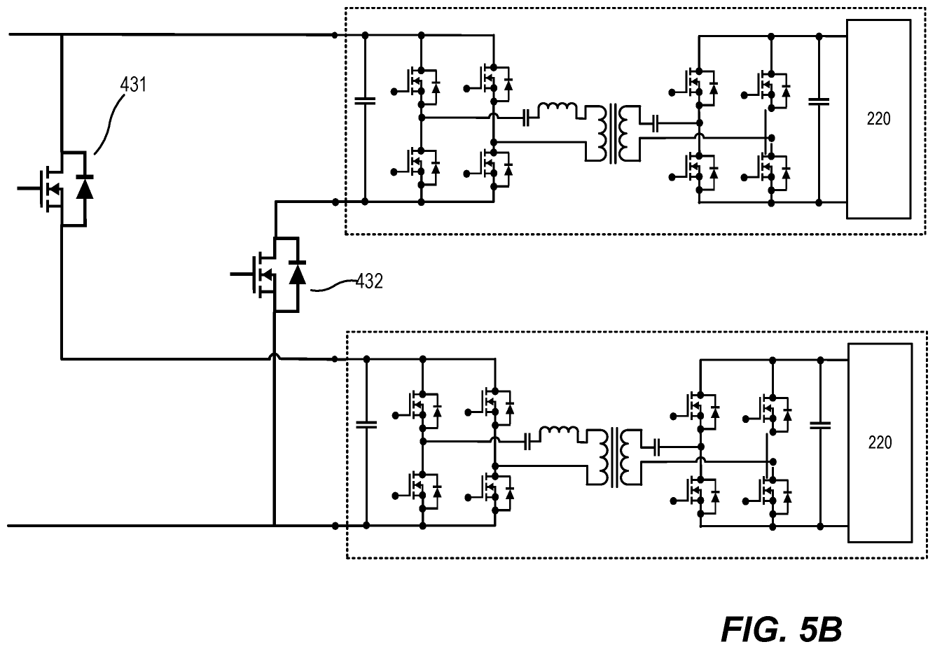

As seen in FIGS. 5A and 5B, the switches 431, 432, 433-1 and 433-2 of the switching matrix 430 may be driven in pairs, with the two separate unidirectional switches 431 and 432 driven as a first pair and the two switches 433-1, 433-2 of the bidirectional switch 433 as a second pair. When one pair is turned on, the other may be turned off. Both pairs of switches may be turned off at the same time.

In FIG. 5A, the two switches 433-1, 433-2 of the bidirectional switch 433 are turned on, and the two separate unidirectional switches 431 and 432 are turned off. Open circuit paths resulting from the opening of the two separate unidirectional switches 431 and 432 are removed from FIG. 5A to illustrate that the driving of the two switches 433-1, 433-2 of the bidirectional switch 433 results in a series connection of the two battery modules 120-1 and 120-2.

In FIG. 5B, the two switches 433-1, 433-2 of the bidirectional switch 433 are turned off, and the two separate unidirectional switches 431 and 432 are turned on. The open circuit path resulting from the opening of the bidirectional switch 433 is removed from FIG. 5B to illustrate that the driving of the two unidirectional switches 431, 432 results in a parallel connection of the two battery modules 120-1 and 120-2.

In other words, when the two unidirectional switches 431, 432 are on and the switches of the bidirectional switch 433 are off, the battery modules 120 are connected in parallel. As a result, the battery modules 120 may provide a low voltage output and/or low voltage input. When the two unidirectional switches 431, 432 are off and the switches of the bidirectional switch 433 are on, the battery modules 120 are connected in series, and therefore may support a high voltage output and/or high voltage input.

As discussed above, the bidirectional DC/DC converter 210, and the transformer 213 thereof, may be implemented with one of a number of different turn ratios. The battery modules 120-1 and 120-2 may therefore have different voltages.

As discussed above, the controller of the bidirectional DC/DC converter 210 may disable the bidirectional DC/DC converter 210 when a fault in battery 220 is detected. In some embodiments, the controller of the switch matrix 430 may disconnect the battery module 120. Accordingly, a failed battery 220 can be isolated by either the bidirectional DC/DC converter 210 or the switch matrix 430, enabling the battery pack 110 to remain operational and providing fault tolerance.

Additional switching devices may be present in the switching network 130 to connect the switching matrix 430 to the first port 140 of the battery pack 110 or to the second port 150 of the battery pack, but are not illustrated in the figures.

The switching network 130 and/or the switching matrix 430 thereof may be controlled by a controller 135 provided within the battery pack 110. The controller may comprise one or more components. The one or more components may be implemented in hardware and/or software. The controller may be embodied as one or more software functions and/or hardware modules. In embodiments, the controller comprises one or more processors configured to process instructions and/or data. Operations performed by the one or more processors may be carried out by hardware and/or software. In embodiments, the controller comprises at least one volatile memory, at least one non-volatile memory, and/or at least one data storage unit. The volatile memory, non-volatile memory and/or data storage unit may be configured to store computer-readable information and/or instructions for use by one or more processors. The controller that controls the switching network 130 may be different from the controller(s) controlling the bidirectional DC/DC converter 210 of each battery module 120, although the present disclosure is not limited thereto. For example the controller that controls the switching network 130 may be configured to send and/or receive control signals to and/or from the controller for the first stage 211 of each battery module 120 and the controller for the second stage 212 of each battery module 120.

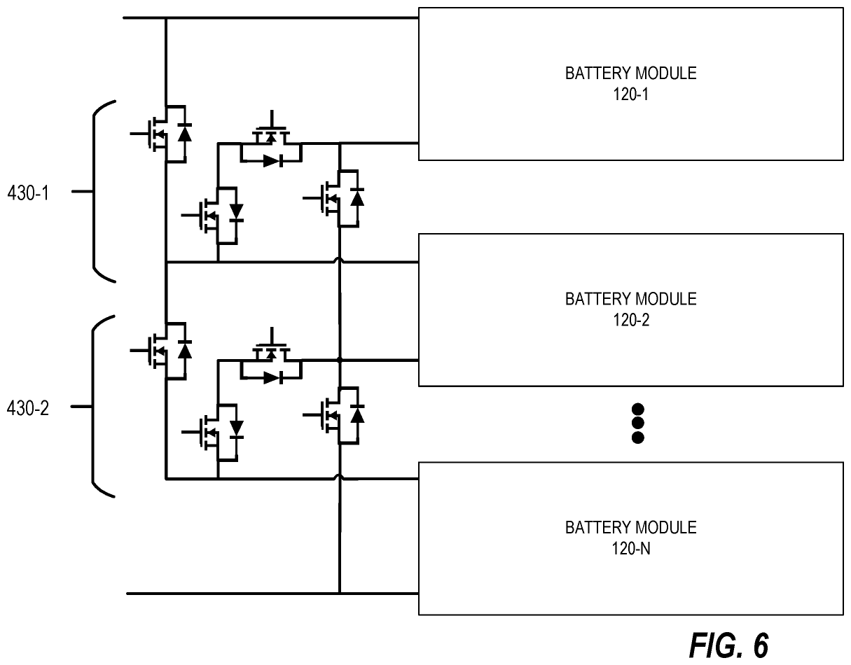

FIG. 6 illustrates aspects of a switching network that enables selective configuration of the bidirectional electrical power system having N battery modules for a higher voltage operation, a lower voltage operation, or an intermediate voltage operation, where N is a natural number greater than or equal to three. As can be seen in FIG. 6, each two adjacent battery modules (e.g., battery modules 120-1 and 120-2, battery modules 120-2 and 120-3) may be connected to a corresponding switching matrix 430. Some battery modules may be connected to two switching matrices 430, such as for example the battery module 120-2.

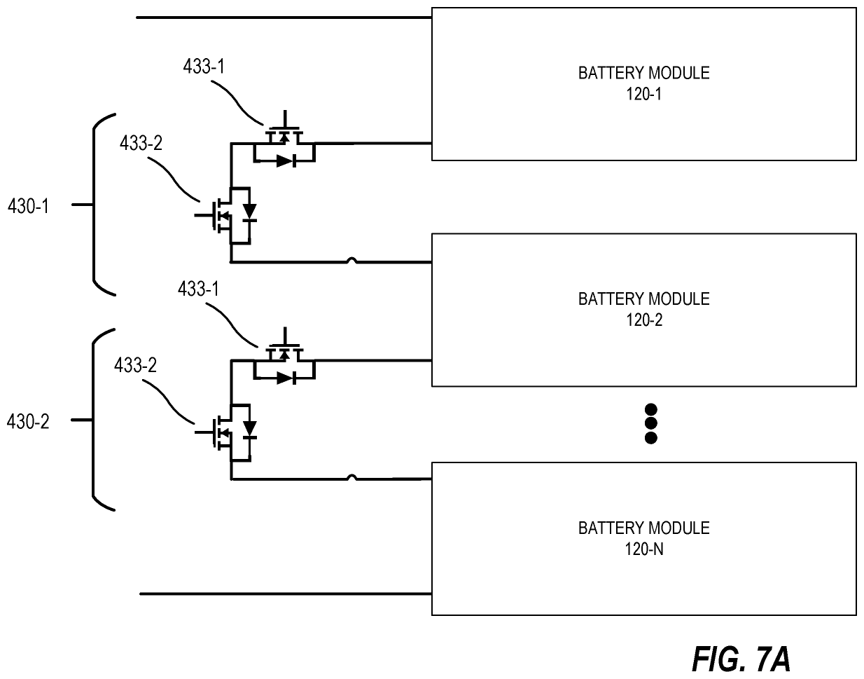

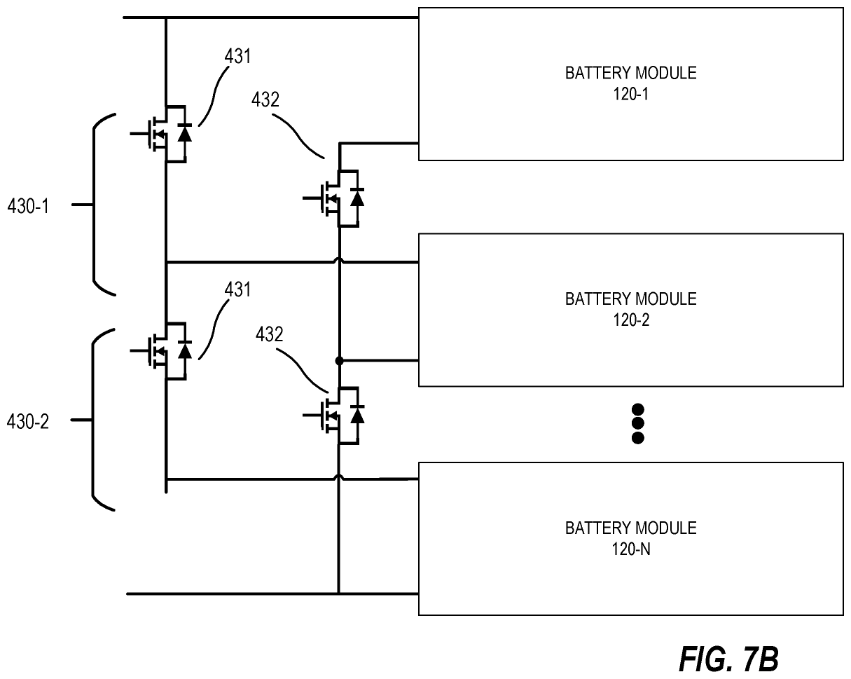

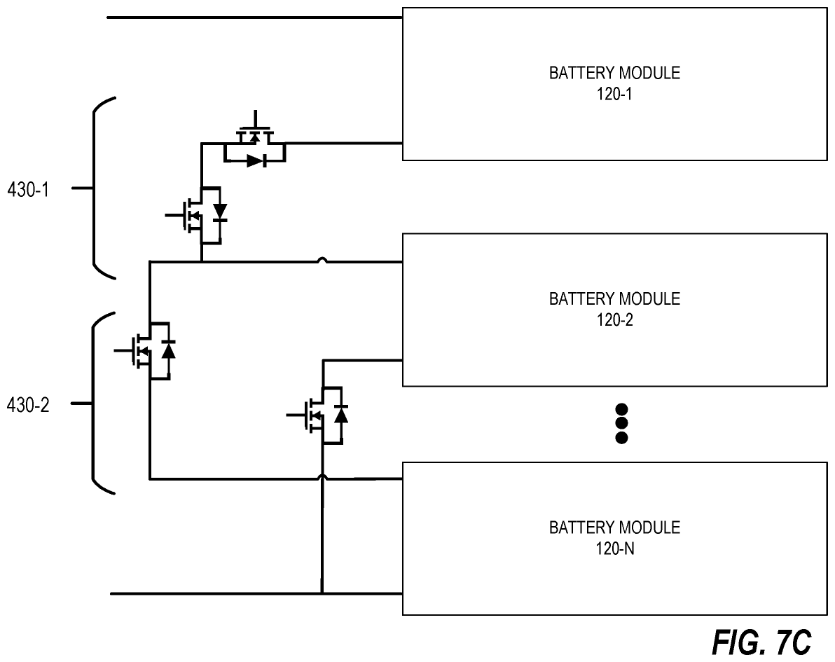

As seen in FIGS. 7A and 7B, the switches 431, 432, 433-1 and 433-2 of each switching matrix 430 may be driven in pairs, with the two separate unidirectional switches 431 and 432 as a first pair and the two switches 433-1, 433-2 of the bidirectional switch 433 as a second pair. When one pair is turned on, the other may be turned off. In FIG. 7A, the two switches 433-1, 433-2 of the bidirectional switch 433 of each switching matrix 430 are turned on, and the two separate unidirectional switches 431 and 432 of each switching matrix 430 are turned off. Open circuit paths resulting from the opening of the two separate unidirectional switches 431 and 432 are removed from FIG. 7A to illustrate that the driving of the two switches 433-1, 433-2 of the bidirectional switch 433 of each switching matrix 430 results in a series connection of the N battery modules 120, where N is a natural number greater than or equal to thee.

In FIG. 7B, the two switches 433-1, 433-2 of the bidirectional switch 433 of each switching matrix 430 are turned off, and the two separate unidirectional switches 431 and 432 of each switching matrix 430 are turned on. The open circuit paths resulting from the opening of the bidirectional switches 433 are removed from FIG. 7B to illustrate that the driving of the two unidirectional switches 431, 432 of each switching matrix 430 results in a parallel connection of the battery modules 120.

In FIG. 7C, the two switches 433-1, 433-2 of the bidirectional switch 433 of a first switching matrix 430-1 are turned on, and the two separate unidirectional switches 431 and 432 are turned off. At the same time, the two separate unidirectional switches 431 and 432 of a second switching matrix 430-2 are turned on, and the two switches 433-1, 433-2 of the bidirectional switch 433 of the second switching matrix 430-2 are turned off. The open circuit paths resulting from the opening of the various switches are removed from FIG. 7C to illustrate that the driving of the two unidirectional switches 431, 432 of the bidirectional switch 433 results in a series connection between a first pair of battery modules 120-1 and 120-2, and a parallel connection between the battery modules of the first pair with the other battery modules 120-3 . . . 120-N.

In embodiments where three or more battery modules 120 are present, they may be connected in parallel, in serial, or in a combination of parallel and serial connections. When the battery modules 120 are all connected in parallel, the battery modules 120 may provide a low voltage output and/or low voltage input. When the battery modules 120 are all connected in series, the battery modules 120 may provide a high voltage output and/or high voltage input. When the battery modules 120 are connected with a combination of parallel and serial connections, the battery modules 120 may provide an intermediate voltage output and/or intermediate voltage input, with the intermediate voltage being between the high voltage of the all-serial connections and the low voltage of the all parallel connections.

The switching network 130 and/or the switching matrices 430 of FIG. 6 may be controlled by a controller (not shown) provided within the battery pack 110. The controller may comprise one or more components and may be implemented as discussed above with the controller discussed with reference to FIG. 4. There may be a plurality of controllers, e.g., one for each switching matrix 430.

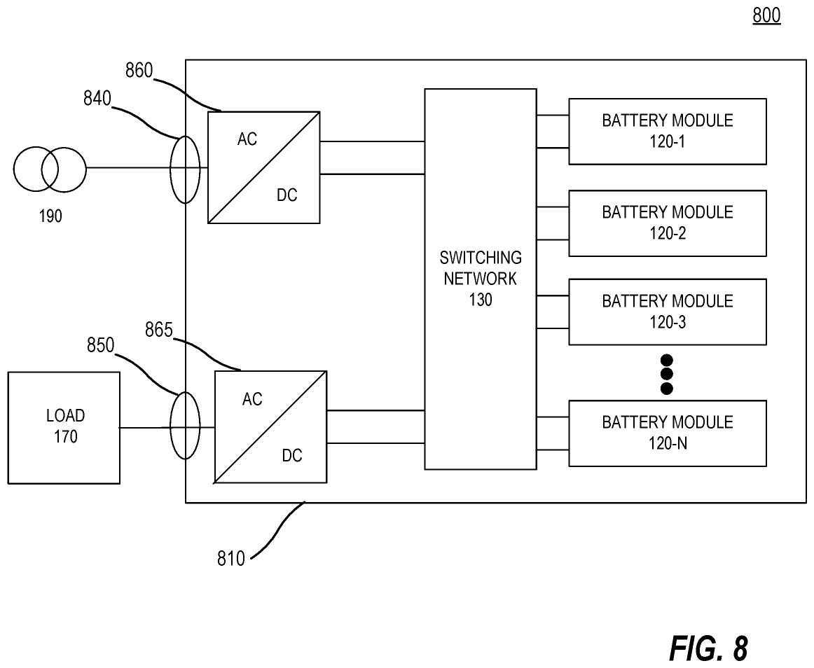

FIG. 8 illustrates aspects of a bidirectional electrical power system according to some embodiments. In FIG. 8, a bidirectional electrical power system 800 may include a battery pack 810 that includes the switching network 130 and the battery modules 120 previously discussed. In addition, first and second AC/DC converters 860 and 865 may be provided within the battery pack 810, with the first AC/DC converter 860 coupled to the first port 840, and the second AC/DC converter 865 coupled to the second port 850.

By providing the first and second AC/DC converter 860 and 865 within the battery pack 810 and coupled respectively to the first port 840 and the second port 850, the battery pack 810 may be able to provide AC power to connect to the grid and or power an AC load (such as a forklift drive motor) directly and without an external converter. In some embodiments, the AC output of the battery pack 810 may be single or 3-phase AC.

There are numerous potential benefits to the inventive concepts of the present disclosure, some of which are discussed herein. For example, the battery packs 110 and 810 may provide both high voltage and low voltage ports for battery pack without requiring significant changes to battery or equipment designs.

The battery packs 110 and 810 may enable fast charging for the batteries 220 therein, which may increase productivity of motive power application and/or lower electric vehicle charging times.

The battery packs 110 and 810 may provide grid support functions for energy storage system and uninterruptible power supply applications. In some embodiments, one or more battery packs 110 and/or 810 may be implemented in an uninterruptible power supply system. In some embodiments, one or more battery packs 110 and/or 810 may be implemented in an energy storage system. The battery packs 110 and 810 may also improve the safety of energy storage systems by avoiding insulation and ground current issues.

The bi-directional DC/DC converters 210 may eliminate use of an additional balancing circuit for the battery modules 120.

The bi-directional DC/DC converters 210 may limit inrush current when the battery modules 120 are connected in parallel.

The battery packs 110 and 810 may provide application interchangeability, where one battery is used in support of multiple applications.

The battery pack 810 providing low voltage AC output may be a battery pack suitable for fitment within a lift truck (e.g., Class 1,2,3 trucks), electric vehicles, and/or residential units (e.g., houses, apartments, and so on). Other classes of vehicles may be supported by the present inventive concepts. The low voltage AC and/or DC outputs may be in a range of, e.g., 24 Volts (V) to 80 V.

The battery pack 810 may provide support for use cases in which inversion/conversion equipment is removed from out of the main vehicle or load electric system and placed into the battery pack, which may improve repairability or replacement.

The battery packs 110 and 810 may be offered in a variety of form factors that are suitable for standard battery trays or compartments, although the present disclosure is not limited thereto.

Aspects of the present disclosure have been described above with reference to the accompanying drawings, in which embodiments of the inventive concepts are shown. It will be appreciated, however, that the inventive concepts may, however, be embodied in many different forms and should not be construed as limited to the embodiments set forth above. Rather, these embodiments are provided so that this disclosure will be thorough and complete, and will fully convey the scope of the inventive concepts to those skilled in the art. Like numbers refer to like elements throughout.

It will be understood that, although the terms first, second, etc. are used throughout this specification to describe various elements, these elements should not be limited by these terms. These terms are only used to distinguish one element from another. For example, a first element could be termed a second element, and, similarly, a second element could be termed a first element, without departing from the scope of the present inventive concepts. The term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In the drawings and specification, there have been disclosed typical embodiments of the inventive concepts and, although specific terms are employed, they are used in a generic and descriptive sense only and not for purposes of limitation, the scope of the inventive concepts being set forth in the following claims.

What is claimed is:

1. A battery pack, comprising:
a first battery module within the battery pack;
a second battery module within the battery pack; and
a switching matrix within the battery pack and configured to connect the first and second battery modules in series or in parallel.

2. The battery pack of claim 1, wherein the switching matrix comprises a high voltage port and a low voltage port.

3. The battery pack of claim 1, wherein the switching matrix comprises first and second solid state switches configured to operate together as a bidirectional switch.

4. The battery pack of claim 3, further comprising a controller configured to control the switching matrix to connect the first and second battery modules in series by turning on the first and second solid state switches configured to operate together as the bidirectional switch.

5. The battery pack of claim 3, wherein the switching matrix further comprises third and fourth solid state switches each configured to operate as a unidirectional switch.

6. The battery pack of claim 5, wherein the first and second battery modules each comprise first and second nodes, and wherein the first and second solid state switches are on an electrical path between the second node of the first battery module and the first node of the second battery module.

7. The battery pack of claim 6, wherein the third solid state switch is on an electrical path between the first node of the first battery module and the first node of the second battery module, and wherein the fourth solid state switch is on an electrical path between the second node of the first battery module and the second node of the second battery module.

8. The battery pack of claim 5, further comprising a controller configured to control the switching matrix to connect the first and second battery modules in series by turning on the first and second solid state switches configured to operate together as the bidirectional switch and to connect the first and second battery modules in parallel by turning on the third and fourth solid state switches.

9. The battery pack of claim 1, further comprising first and second ports.

10. The battery pack of claim 9, wherein the first port is a high voltage port configured to connect to a grid power supply.

11. The battery pack of claim 10, wherein the second port is a low voltage port configured to connect to a load powered by the battery pack.

12. The battery pack of claim 1, wherein each of the first and second battery modules comprises a lithium-ion battery.

13. The battery pack of claim 1, further comprising an alternating current (AC)/DC converter.

14. The battery pack of claim 1, wherein the first battery module and the second battery module each comprise a direct current/direct current (DC/DC) converter.

15. A battery pack, comprising:
a first battery module within the battery pack;
a second battery module within the battery pack;
a third battery module within the battery pack;
a first switching matrix within the battery pack and configured to connect the first and second battery modules in series or in parallel; and
a second switching matrix within the battery pack and configured to connect the second and third battery modules in series or in parallel.

16. The battery pack of claim 15, further comprising a controller configured to control the first switching matrix to connect the first and second battery modules in series and the second switching matrix to connect the series-connected first and second battery modules in parallel with the third battery module.

17. The battery pack of claim 15, wherein each switching matrix comprises first and second solid state switches configured to operate together as a bidirectional switch, and third and fourth solid state switches each configured to operate as a unidirectional switch.

18. A battery pack, comprising:
at least two battery modules within the battery pack;
a switching network within the battery pack and configured to connect the at least two battery modules in series, in parallel, or in a combination of series and parallel; and
first and second alternating current/direct current (AC/DC) converters, each coupled to a respective port of the battery pack.

19. The battery pack of claim 18, wherein the switching network comprises first and second solid state switches configured to operate together as a bidirectional switch to connect first and second of the at least two battery modules in series, and third and fourth solid state switches each configured to operate as a unidirectional switch to connect the first and second of the at least two battery modules in parallel.

20. The battery pack of claim 18, wherein each of the at least two battery modules comprises a DC/DC converter.
